(19) United States
(12) Patent Application Publication
(10) Pub. No.: US 2017/0328530 A1
(43) Pub. Date: Nov. 16, 2017

(54) LIGHTING DEVICE MADE UP OF LIGHTING ELEMENTS AND STRIPLIGHT MADE UP OF A PLURALITY OF SUCH LIGHTING DEVICES

(71) Applicant: Stephane BOCHENEK, Yerres (FR)

(72) Inventor: Stephane BOCHENEK, Yerres (FR)

(21) Appl. No.: 15/189,865

(22) Filed: Jun. 22, 2016

(30) Foreign Application Priority Data
May 13, 2016 (EP) 16169730.5

(51) Int. Cl. F21S 9/02; F21V 15/01; F21V 3/02; F21V 3/04; G08B 13/196; F21V 23/02

(52) U.S. Cl. CPC F21S 9/02; G08B 13/19632; F21V 23/02; F21V 3/02; F21V 3/0409; F21V 15/01

(57) ABSTRACT

Said lighting device is made up of lighting elements (L1, L2, . . . , L20) arranged on a mounting board (PS1, PS2, etc.). The one or more boards are arranged so as to supply light with a predetermined coverage.

The boards comprise a plugging system (C1, C2, C3, P1, P2, P3) for connecting said lighting elements. The mounting of such a device using a threaded rod 7 makes it possible to obtain easy maintenance of the device of the invention. This device can easily be used to form striplights.

Use: Lighting of car parks, meeting rooms.

The present invention relates to a lighting device made up of lighting elements and a supply circuit for powering said elements.

The present invention also relates to a striplight made up of a plurality of such lighting devices.

Such devices are generally known, especially those that use LEDs as lighting elements. LEDs provide powerful light considering the electric power they consume. Many applications require intense omnidirectional lighting, while LEDs instead provide highly directional light outputs.

The aim of the invention is to provide a lamp that benefits from the efficiency of LEDs and which lights in an omnidirectional manner, while making it possible to obtain high light intensity.

For this purpose, a device of the type mentioned in the preamble is characterised in that said elements are organised in at least one assembly of at least one lighting element.

According to one aspect of the invention, the device comprises a plurality of said assemblies arranged on at least one mounting board and arranged so as to provide lighting according to a predetermined coverage.

Thus, by increasing the number of assemblies guided in different directions, omnidirectional lighting or lighting having a given light coverage is obtained, as well as luminosity which can be stronger.

One interesting application of the invention is that which relates to lighting in car parks, which requires easy maintenance and installation.

For maintenance, the invention proposes a system for plugging in boards in order to facilitate the replacement thereof in the event of a fault. As regards ease of installation, the supply circuit is of a type controlled to adjust the supply voltage of the lighting elements by also compensating for possible voltage drops due to the length of the power cable intended for powering the striplight. Indeed, when dealing with a striplight comprising such devices, the accessible voltage at the end of the striplight is considerably lower than at the start. It should be noted that the power cable, preferably carrying a low voltage, does not require any precautions or authorisation for the installation of such a striplight.

The following description, supported by the appended drawings, all provided as a non-limiting example, will easily explain how the invention can be carried out. In the drawings:

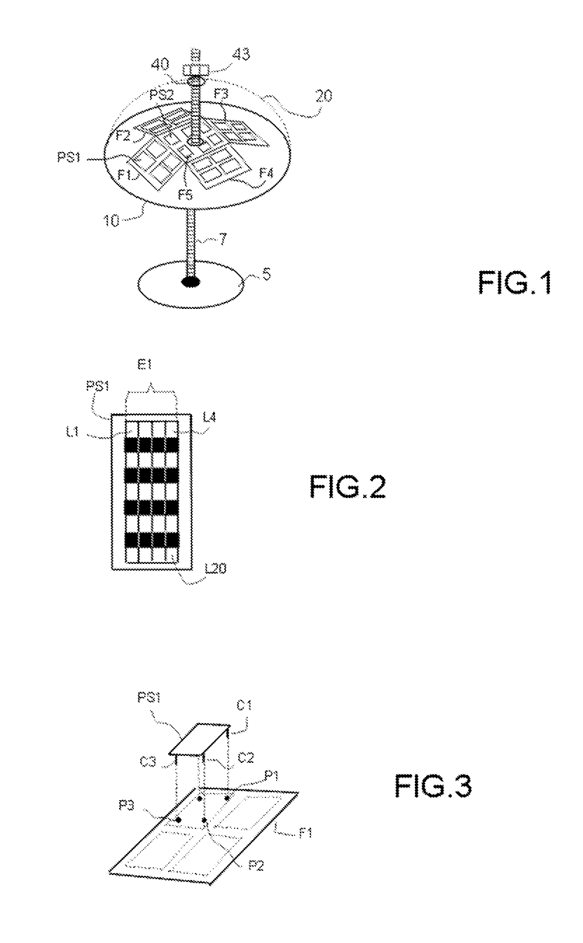

FIG. 1 shows in perspective a lighting device in accordance with the invention,

FIG. 2 shows a board for assemblies of lighting elements that is suitable for a device according to the invention,

FIG. 3 shows how said boards of assemblies are plugged into light facets placed on the supporting plate of the device,

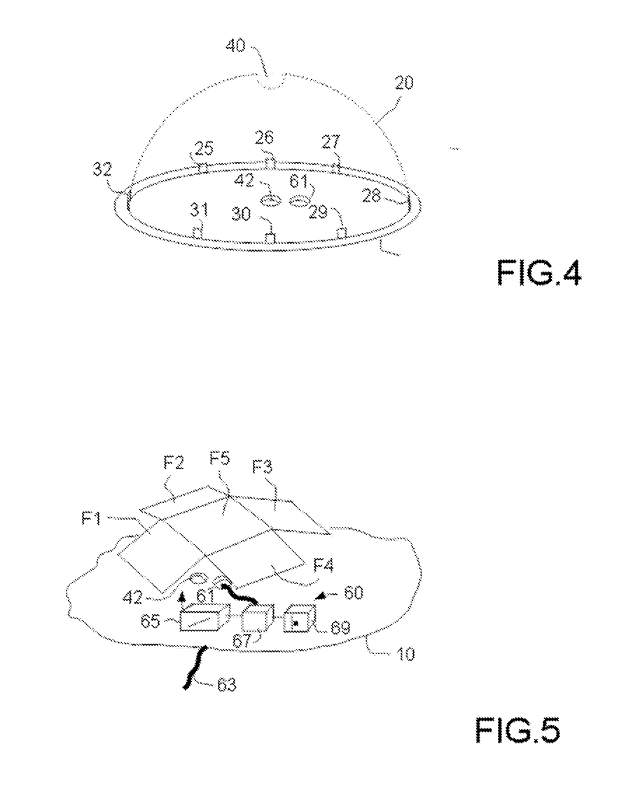

FIG. 4 shows how the protective dome of the device is arranged on the supporting plate,

FIG. 5 shows an arrangement of the supply elements of said device of the invention,

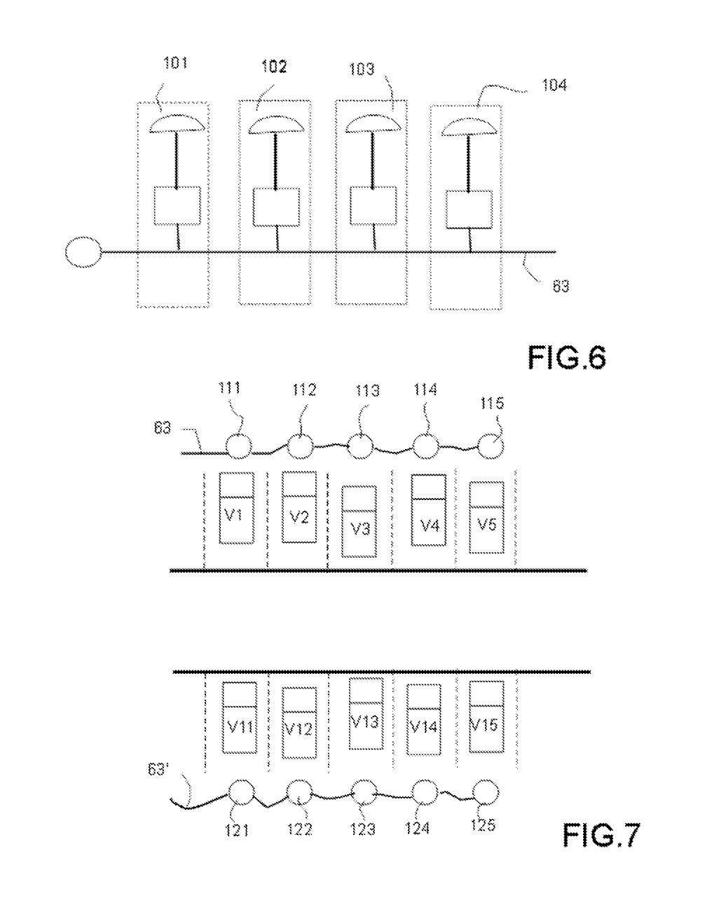

FIG. 6 shows a strip of lighting devices in accordance with the invention,

FIG. 7 shows strips in accordance with the invention for lighting a car park,

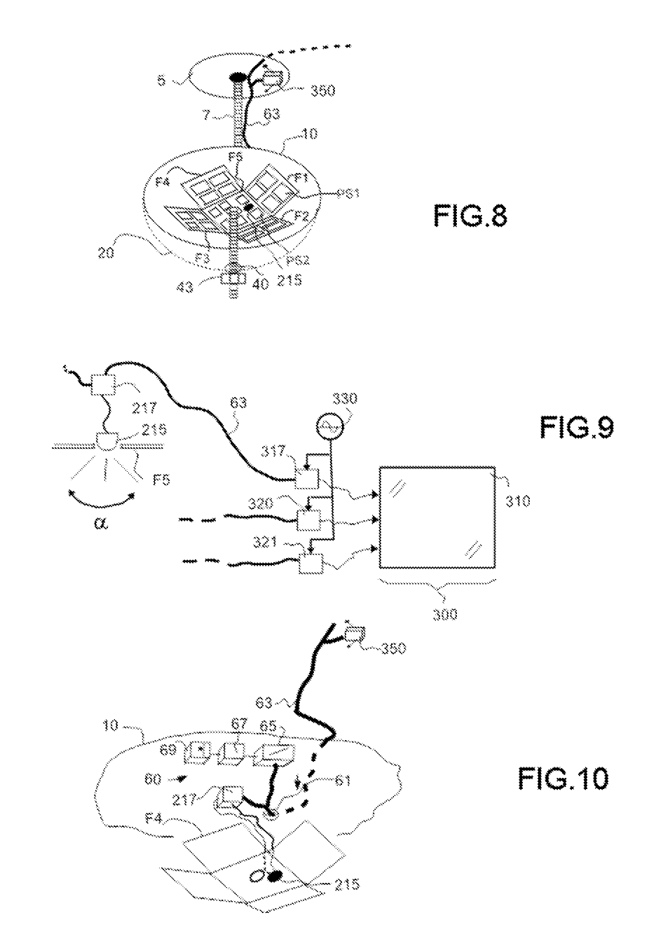

FIG. 8 shows an example of an embodiment of a lighting device in accordance with the invention,

FIG. 9 shows the transmission of images involving the device shown in FIG. 8,

FIG. 10 explains the connections of the device shown in FIG. 8.

In these figures, the common elements all have the same references in all the figures.

In FIG. 1, the lighting device shown is made up of a circular base 5, for example. The end of a threaded rod 7 is secured to the centre of this base. A supporting plate 10 with said threaded rod 7 passing through same is secured at a certain distance from the base 5. This distance is determined by a nut, not shown, which blocks the vertical movement of this supporting plate 10. Light facets F1, F2, F3, F4 and F5 are arranged on said supporting plate. Mounting boards are secured to said facets, some of which (PS1, PS2, etc.) are only referenced in the figure in order to avoid crowding it. An assembly E1 of lighting elements L1 to L20 is placed on each of these boards, as shown in FIG. 2. The positioning of the facets and even of said boards makes it possible to adjust the direction and spatial distribution of the light beams.

FIG. 3 shows that the mounting boards PS1 are removable with a view to facilitate the replacement thereof. For this purpose, connectors C1, C2, C3, etc. secured to the boards PS1 are provided on said boards and engage with sockets P1, P2, P3 respectively arranged on the light facets (F1, etc.).

The lighting device comprises a protective dome made of transparent material such as polymethyl methacrylate, better known by its commercial name of “Plexiglas”. This dome 20 is provided with a semi-spherical shape, and its base rests on the supporting plate 10. Lugs 25, 26, 27, . . . , 31 are provided in order to centre said dome, as shown in FIG. 4. These lugs are arranged at the periphery of the supporting plate 10. A hole 40 at the top of this dome allows the threaded rod 7 to be pass through same. Another hole 61, visible in FIG. 4, is made in the supporting plate 10 for passing a cable 63. A nut 43 holds said dome 20 against the supporting plate 10.

A supply circuit 60 is placed under the light facets F1 to F5. Said circuit is connected to the power cable 63 which passes through the hole 61. Said circuit is made up of a transformer 65, control electronics 67 and an accumulator system 69. The transformer is of a controlled type which provides, in particular for lighting, a predetermined voltage for a voltage range which is applied at the input thereof. The accumulator 69 preserves the lighting during a power cut and can also supply a backup voltage to at least one lighting element.

The mounting of the device of the invention by means of a threaded rod allows for easy removal which, associated with the possibility of easily changing the mounting boards (PS1 etc.) allows for very easy maintenance of said device.

Advantageously, the devices of the invention are well suited to a strip configuration. The invention makes it possible to play with the distribution of light by tilting the various facets (F1, F2, etc.) in order to obtain the required distribution or coverage of each device. Moreover, the voltage control provided by the controlled transformers makes it possible to obtain long-span striplights without any deterioration of the light intensity at the end of the line. FIG. 6 shows the structure of such a striplight, which is made up of a plurality of devices in accordance with the invention 100, 101, 102, 103, which are all connected to a power cable 63.

One field of application of such a striplight is the lighting of a car park. This is shown in FIG. 7. The car park is made up of two rows: a first row for vehicles V1, V2, . . . , V5 and a second row for vehicles V11, V12, . . . , V15. A striplight is assigned to each of these rows. A first striplight is assigned to the first row and is made up of lighting devices 111, 112, 113, 114 and 115. These devices are powered by the cable 63. A second row is illuminated by the lighting devices 121, 122, 123, 124 and 125. They are powered via a power cable 63′. It should be noted that since such striplights can have a low voltage value, these lamps do pose any danger during crashes with manoeuvring vehicles.

Another example of a use of the invention is shown in FIG. 8. In this example, the lamp is attached to the ceiling of a room and a video camera 210 has been inserted for surveillance of this room. The lens of this camera is flush with the outside of the facet F5, as shown in FIG. 9. Its arrangement is such that it makes it possible to view objects according to an angle a which is as large as possible, and it is recessed enough to avoid the glare from the surrounding LEDs.

This camera 215 is connected to a PLC device 217 (device for coupling by powerline communication) which makes it possible to transmit a supply current and data over a single line, and thus to transmit the images captured by the camera 215 to a surveillance centre 300 in order to be viewed on a screen 310. The images can be accessed in the surveillance centre 300 by another PLC device 317, by travelling through the cable 63. Reference 330 indicates a power source for at least one lamp. The surveillance centre 300 can be provided with various PLC devices 320, 321, etc., assigned to various cameras which are part of various lamps.

FIG. 10 shows that, just like in FIG. 5, the various elements, including the coupling device 217, are placed under the light facets F1, . . . , F5.

The lighting device can also be used in the context of lighting a room such as an office or a meeting room. It is possible to attach a strong Wi-Fi booster of the type used in this type of room to the base 5 of the lamp. This is indicated by reference 350. This allows the participants meeting in the work room to connect easily to the Wi-Fi network.

1) Lighting device comprising:
lighting elements arranged in one or more assemblies;
a supply circuit for powering the lighting elements;
one or more light facets;
one or more mounting boards arranged on the one or more light facets, each of the one or more assemblies being positioned on a corresponding one of the one or more mounting boards, the light facets being arranged so as to provide light in accordance with a predetermined coverage, and
a plug-in system that provides electrical connection between the lighting elements and the supply circuit

2) Lighting device according to claim 1, wherein a plurality of mounting boards are arranged on each light facet.

3) (canceled)

4) Lighting device according to claim 1, wherein the supply circuit comprises an accumulator system for supplying a backup voltage to at least one of the lighting elements.

5) Lighting device according to claim 1, further comprising a supporting plate on which the one or more assemblies rest.

6) (canceled)

7) Lighting device according to claim 1, further comprising a transparent protective dome covering the one or more assemblies.

8) Lighting device according to claim 5, wherein the supporting plate comprises centring lugs arranged on a perimeter thereof for centering the dome.

9) Lighting device according to claim 5, wherein a threaded rod is provided for supporting at least said supporting plate and said dome.

10) Lighting device according to claim 1, wherein the supply circuit comprises an electric transformer member for supplying a supply voltage with a given value in accordance with an input voltage having variable voltages.

11) Lighting device according to claim 1, wherein at least one of said lighting elements are made up of at least one LED.

12) Lighting device according to claim 1, wherein a video camera is arranged in the lighting device.

13) Lighting device according to claim 12, wherein images are transmitted via a power cable of the lighting device by a PLC coupling circuit.

14) Lighting device according to claim 1, further comprising a Wi-Fi booster in a base of the lighting device.

15) Striplight made up of a plurality of said lighting devices according to claim 1, powered by a power cable.
